(19) United States
(12) Patent Application Publication
(10) Pub. No.: US 2013/0062891 A1
(43) Pub. Date: Mar. 14, 2013

(54) ENGINE CRANKING MOTOR SOFT-START SYSTEM AND METHOD

(71) Applicant: Frank J. Bourbeau, Santa Barbara, CA (US)

(72) Inventor: Frank J. Bourbeau, Santa Barbara, CA (US)

(73) Assignee: Enerpro, Inc.

(21) Appl. No.: 13/558,050

(22) Filed: Jul. 25, 2012

Related U.S. Application Data
(60) Provisional application No. 61/532,242, filed on Sep. 8, 2011.

(51) Int. Cl. F02N 11/08

(52) U.S. Cl. 290/38 C

(57) ABSTRACT

An engine cranking motor soft-start system and method includes at least one cranking motor and a switching power converter which is coupled to the cranking motors such that the voltage across the motors varies with the converter's duty cycle. The duty cycle, and thereby the voltage across the motors, is gradually increased over a predetermined period. This serves to limit the acceleration of the cranking motors, and thereby their peak current and torque, which may serve to increase their service life. The cranking motors are typically operatively coupled to drive respective pinion gears which are brought into engagement with a ring gear when starting the engine. The system is preferably arranged such that the gradually increasing duty cycle results in the torque of the cranking motors being sufficient to break an abutment that may be present between the pinion gears and the ring gear.

### RELATED APPLICATIONS

This application claims the benefit of provisional patent application No. 61/532,242 to Bourbeau, filed Sep. 8, 2011.

### BACKGROUND OF THE INVENTION

1. Field of the Invention

This invention relates to the field of engine cranking motors, and particularly to systems and methods for soft-starting cranking motors used in diesel-electric locomotive engines.

2. Description of the Related Art

High fuel costs and increasingly strict air pollution regulations have increased the frequency of engine starts in diesel-powered locomotives, highway trucks and off-road vehicles. More engine starts have increased the failure rate of the cranking motors and gears used to start these large engines.

Engines of this sort typically have one or two cranking motors. A schematic diagram for a conventional ‘contactor-switched hard-start’ system using one cranking motor is shown in FIG. 1a. A 24 volt battery 1 powers the system, which includes a 24 volt cranking motor 2 and a motor-mounted solenoid 4, with the solenoid including a solenoid hold coil 5, a pull-in coil 6, contacts 7, control terminals S (start) and G (ground), and power terminals B (battery connection) and M (motor connection). The solenoid also has a spring-loaded plunger which is controlled by the pull-in and hold coils and is coupled to the cranking motor with a clevis and pawl linkage which converts the rectilinear motion of the solenoid plunger into the motion of a pinion gear 8 along the splined shaft of the cranking motor and into mesh with engine flywheel ring gear 9. The conventional locomotive cranking system also includes a control relay. The coil 11 of this relay is energized by closing a start switch 10 which closes the single pole contacts 12 of the control relay to initiate the engine start sequence. Closure of the relay contacts applies battery voltage to the hold coil 5 and the pull-in coil 6 of solenoid 4. The hold coil return goes directly to the battery negative via the G terminal. The return of the low resistance pull-in coil at the M terminal goes to battery negative via the cranking motor armature and series field windings. These windings have very low resistance and no counter EMF before the motor begins to rotate. As a result, virtually all of the battery voltage is dropped across pull-in coil 6 before the solenoid contacts 7 close.

The spring loaded solenoid plunger retracts in response to the magnetic field produced by the hold and pull-in coil currents. In cooperation with the clevis and pawl linkage, the plunger retraction first moves pinion gear 8 into engagement with engine flywheel ring gear 9 and then closes solenoid contacts 7. The closure of the solenoid contacts also removes battery voltage from pull-in coil 6, thus eliminating the possibility of over-heating the short-time rated low resistance pull-in coil. In normal operation, the pinion gear 8 engages the ring gear 9, the pinion gear slides into mesh with the ring gear and the solenoid contacts 7 close to connect the motor to the battery. The longer-time rated hold coil keeps the solenoid plunger pulled in until the engine starts.

The momentary flow of pull-in coil current through the windings of cranking motor 2 produces a moderate amount of motor torque, which in turn causes pinion gear 8 to rotate slowly as it moves toward ring gear 9. This rotary motion is intended to reduce the probability of a “sticking” abutment in the event that the faces of the pinion and ring gears touch when the planes of the two gears meet. Sticking abutments frequently occur during locomotive engine cranking in spite of the low speed rotation provided by the pull-in coil current passing through the cranking motor windings. To reduce the probability of sticking abutments, locomotive cranking systems sometimes shunt the two pull-in coils with additional resistance to increase the net momentary current in the motor windings. This approach is illustrated in, for example, a locomotive service manual such as EMD SD70MAC Locomotive Service Manual, P.N. 500049EP.

Avoiding a sticking abutment by spinning the pinion gear before it engages the ring gear is problematic because: 1) high motor friction may result in insufficient torque to break the abutment, and 2) compensating for high friction by reducing the resistance between the battery and motor may result in motor over-speed if the pinion gear fails to move because of a stuck solenoid plunger.

The high moment of inertia of the engine and its load cause motor current and torque to reach extreme levels before the motor reaches a speed where its counter-EMF acts to reduce the current and torque. High initial current burns the cranking motor commutator bars and carbon brushes, and high initial torque accelerates the wear-out of the pinion and ring gears as well as the motor nose bearing. The problem of high initial current and torque is aggravated in the diesel-electric locomotive (and in stationary engine generator power plants as well) by the added moment of inertia of the traction alternator and the companion alternator. The rotating mass of these machines extends the duration of high current during the acceleration phase of the start sequence.

Curves of per-unit voltage 13, current 14 and torque 15 are sketched in FIG. 1b for a contactor-switched hard-start system such as that shown in FIG. 1a. Peak current can exceed 2.0 per-unit, with peak torque approaching 3.0 per-unit.

A hard-start system which employs two cranking motors is shown in FIG. 2. The 32 cell battery 17 produces an open circuit voltage of about 64 V. The series-connected cranking motors 18 and 19 each operate on half of the battery voltage. Two-motor cranking is similar to single motor cranking except for the need for additional elements to prevent motor over-speed of one motor in the event of a fault in the solenoid of the other motor.

Two-motor cranking does not permit the solenoid contacts to be used for connecting the motor to the battery. Instead, a power contactor controlled by the solenoid contacts must be provided for that purpose. Solenoids 29 and 30 of FIG. 2 intended for use with two cranking motors have different internal connections than the single cranking motor solenoid 4 of FIG. 1a where the solenoid contacts serve to connect the motor directly to the battery rather than to a contactor coil. The per-unit motor voltage, current and torque response for a two-motor system of this sort is similar to the response of the single motor cranking system.

The sequence of operations for a hard-start system such as that shown in FIG. 2 is:

1. A locomotive control computer (not shown) closes the start switch 20 which energizes the coil 22 of the 4-pole pilot relay.
2. Pilot relay contacts 23, 24, 25 and 26 close.
3. Battery voltage is applied to the two series-connected hold coils 27 and 28 of solenoids 29 and 30. Current to the two pull-in coils 31 and 32 is routed through the low resistance windings of the motors 18 and 19.
4. The magnetic forces created by the currents in the solenoid pull-in and hold coils cause the solenoid plungers to begin to retract into the solenoid cavities, compressing a spring in the process. The action of the pawl and clevis mechanisms causes the pinion gears 33 and 34, splined to the armature shafts, to begin to move forward toward the ring gear 35.
5. Simultaneous with the rectilinear motion of the pinion gears 33 and 34, the cranking motors 18 and 19 begin to rotate due to the current passing through the pull-in coils 31 and 32, augmented by current from two low resistance resistors 36 and 37.
6. When the plane of the pinion gear face reaches the plane of the ring gear face, the two gears either slide into mesh, or the edges of the gears abut (about 30% probability). If the motor's angular momentum combined with the torque produced by current in the low resistance resistors and the pull-in coils is sufficient, the abutment static friction is broken and the two gears slide into mesh.
7. Again referring to prior art circuit of FIG. 2, solenoid contacts 38 and 39 close after the gears mesh, applying battery voltage to the coils 40 and 41 of two single-pole contactors via the now closed auxiliary contacts 25 and 26 of the pilot relays.
8. The contacts 42 and 43 of the two contactors close to apply the battery voltage to the positive and negative terminals of the two series-connected cranking motors 18 and 19 while removing battery voltage from the pull-in coils. The current in the hold coils remains to keep the solenoid plungers pulled in, thus maintaining the engagement of the pinion and ring gears.
9. If a cranking motor's angular momentum augmented by current through the pull-in coils and the low resistance resistors is insufficient to overcome the abutment friction, the rotation of pinion gears 33 and 34 stops and motor current increases to a limit set by the resistance of the parallel combination of the two pull-in coils and the two low resistance resistors. In this event, the locomotive control computer opens relay contacts 20 to abort the engine starting sequence.

The cranking operation is terminated after the engine speed reaches the firing speed by the opening of switch 20 and the subsequent removal of voltage from the pilot relay coil 22. The pilot relay contacts 23 and 24 open to de-energize the solenoid and pilot relay contacts 25 and 26 open to de-energize coils 40 and 41 of the two contactors. Contactor contacts 42 and 43 then open to remove the battery voltage from the motors. Motor rotation stops and the previously compressed spring in the solenoid pulls the pinion gears out of mesh with the ring gear 35.

Cranking is also terminated if engine firing has not been achieved before a time limit of typically 20 s is reached.

The start sequence is aborted if abutment occurs and is not broken by the momentum of the cranking motor's pre-engagement spin, or by torque from motor current.

The per-unit voltage, current and torque profiles (not shown) are similar to those for the single motor hard-start system shown in FIG. 1b. As before, peak current and torque can reach damaging levels with each engine start.

### SUMMARY OF THE INVENTION

An engine cranking motor soft-start system and method are presented which tends to: 1. increase the number of engine starts before the cranking motor wears out, and 2. reduce the probability of an aborted engine start caused by gear face abutment.

The present soft-start engine cranking system is for engines that employ an electric cranking motor to start an engine. The system includes at least one cranking motor and a switching power converter having an output which is coupled to the cranking motors such that the voltage across the cranking motors varies in proportion to the duty cycle at which the switching power converter is operated. The system is arranged such that the duty cycle of the switching power converter, and thereby the voltage across the cranking motors, is gradually increased over a predetermined period. This serves to limit the acceleration of the cranking motor, and thereby its peak current and torque, which serves to increase the service life of the motor.

The cranking motor is typically operatively coupled to drive a pinion gear which is brought into engagement with a ring gear when starting the engine. The system is preferably arranged such that the gradually increasing duty cycle of the switching power converter results in the torque of the cranking motor being sufficient to break an abutment that may be present between the pinion and ring gears.

The present system can be adapted for use with starting systems that employ a single cranking motor, or more than one cranking motor. The system may also be arranged to employ a cranking motor arrangement rated to operate at a voltage less than that provided by the battery, which may enable the use of less costly cranking motors. In this case, the duty cycle of the switching power converter is preferably arranged to limit the voltage across the cranking motor to no more than its rated value.

Novel features of the present system and method include:

1. Ramp voltage instead of step voltage reduces the current and torque required to accelerate the inertia of the engine and its load.
2. Charging the switching power converter bus capacitor through the solenoid pull-in coil(s) eliminates the need for a surge rated resistor(s).
3. Controlling the motor voltage with a buck converter provides motor current greater than battery current when motor voltage is less than battery voltage. Results: 1. Before the contactor contacts close and battery current is limited by the bus capacitor pre-charge resistance, enough motor current is available to break a gear abutment, and 2. Less battery charge is required to start the engine.
4. The power converter allows the use of twin 24 V motors in a 64 V cranking system. Motor cost is reduced and speed capability is increased.

Further features and advantages of the invention will be apparent to those skilled in the art from the following detailed description, taken together with the accompanying drawings.

### BRIEF DESCRIPTION OF THE DRAWINGS

FIG. 1a is a schematic diagram of a known contactor-switched hard-start system using one cranking motor.

FIG. 1b is a graph depicting current, torque and voltage for the cranking motor shown in FIG. 1a.

FIG. 2 is a schematic diagram of a known contactor-switched hard-start system using two cranking motors.

FIG. 3a is a schematic diagram of an engine cranking motor soft-start system per the present invention, which employs one cranking motor.

FIG. 3b is a graph depicting current, torque and voltage for the one motor soft-start cranking system shown in FIG. 3a and the two-motor soft-start cranking system shown in FIG. 4.

FIG. 4 is a schematic diagram of an engine cranking motor soft-start system per the present invention, which employs two cranking motors.

FIG. 5a is a schematic diagram depicting a solenoid pull-in control circuit as might be used in an engine cranking motor soft-start system per the present invention.

FIG. 5b shows signal waveforms for the solenoid pull-in controller shown in FIG. 5a.

FIG. 6a is a schematic diagram of a PWM circuit that ramps up the motor voltage over a pre-set time period.

FIG. 6b shows the output PWM signal of the PWM controller device and the gate-to-cathode voltage of the high current MOSFET transistor that limits the peak cranking motor current.

FIG. 7a shows the circuit diagram of a cranking speed limit circuit per the present invention.

FIG. 7b depicts speed vs. time profiles with two 32 V motors connected in series and soft-started from a 32 cell fully charged battery.

FIG. 8a depicts diesel engine cranking speed with 32 V motors and a 32 cell battery with fully charged and partially charged batteries.

FIG. 8b depicts diesel engine cranking speed with 24 V motors and a 32 cell battery with fully charged and partially charged batteries.

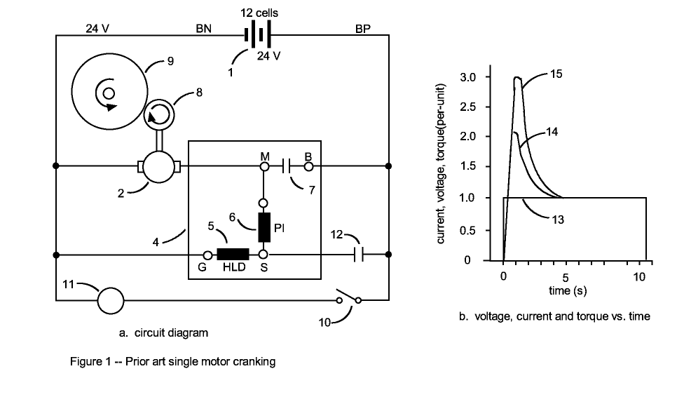

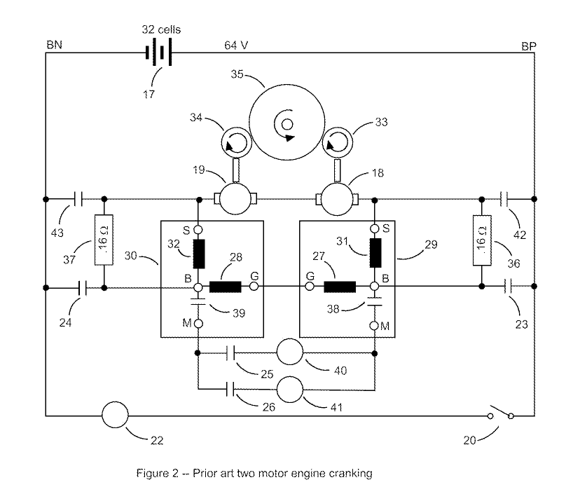

### DETAILED DESCRIPTION OF THE INVENTION

The present engine cranking motor soft-start system is designed to increase the cranking motor service life by using power electronics to limit the acceleration of the engine, and thereby reduce the cranking motor's peak current and torque. One primary application relates to diesel-electric locomotive engines formerly manufactured by the Electro-Motive Division of the General Motors Corporation, and more recently by the Electro-Motive Diesel Division of the Caterpillar Corporation. These locomotives use two 32 V series-wound cranking motors connected in series, which are powered by a 32 cell 64 V lead-acid battery with a typical capacity of 500 A-h.

The acceleration of the engine being started is limited by using a switching power converter to gradually ramp up the voltage across the cranking motor. When implemented as described herein, the use of a switching power converter in this way serves to reduce peak cranking motor current and peak cranking motor torque, enables the engine to be started with reduced battery current and charge, and eliminates failure-to-crank due to gear abutment. The system can be used for single or multiple motor cranking systems; both single and two motor systems are described below.

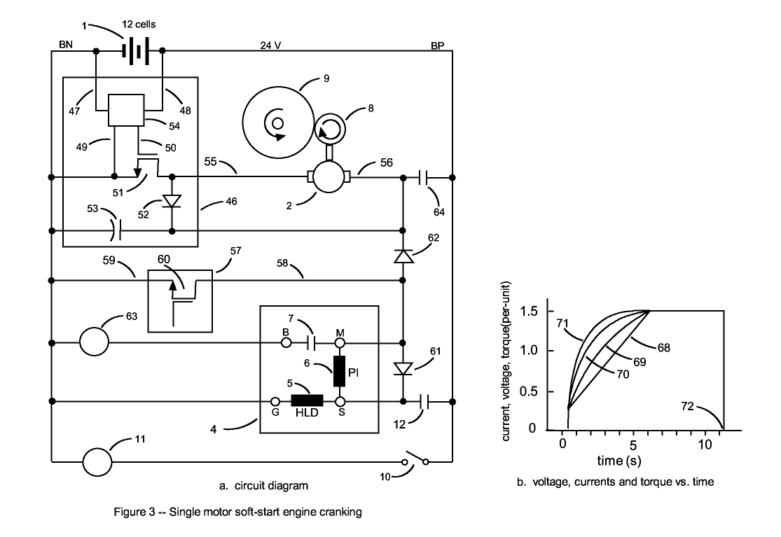

The switching power converter output is coupled to the cranking motor or motors such that the voltage across the motor(s) varies with the duty cycle at which the switching power converter is operated. The system is then arranged such that the duty cycle of the converter, and thereby the voltage across the cranking motors, is gradually increased over a predetermined period. A circuit diagram of an exemplary embodiment of such a system for a single cranking motor is shown in FIG. 3a. Here, a switching power converter 46—preferably a pulse width-modulated (PWM) buck converter—is connected between the motor negative terminal 55 and the battery negative (BN) while the motor positive terminal 56 is connected to battery positive through the contacts 64 of a dc contactor. This is the low-side switch buck converter configuration. The high side switch configuration can also be used; here the switch would be connected between battery positive and the motor positive.

Converter 46 preferably consists of a switching transistor 51 (alternatively referred to herein as the ‘soft-start transistor’) connected between the negative terminal of cranking motor 2 and battery negative, a free-wheeling diode 52 connected in parallel with the cranking motor, a high capacitance (typically 0.1 F) DC bus capacitor 53 connected between battery negative and the-positive terminal of cranking motor 2, and a pulse width modulator (PWM) controller unit 54. The preferred switching transistor type is a high current (e.g., 1500+A rated) metal oxide semiconductor field effect transistor (MOSFET) module and the free-wheeling diode is preferably a high current fast recovery epitaxial diode (FRED) module, though these components may be implemented with transistor and diode technologies having reduced on-state voltages and switching losses as they are developed.

When the converter 46 is activated, PWM controller 54 increases the percentage on-time of soft-start transistor 51—and thus the converter's duty cycle—from, for example, 15% to 100% over a period of, for example, 6 seconds. This results in a ramp increase in cranking motor voltage. As is discussed in more detail below, this gradual increase in cranking motor voltage prevents the high cranking motor current and torque conditions that can occur with prior art hard-start systems.

A soft-start system in accordance with the present invention would typically also include a solenoid pull-in control circuit 57 shown in FIG. 3a which activates the pull-in coil 6 of solenoid 4. Solenoid 4 includes a hold coil 5, contacts 7, terminals S and G, and power terminals B and M. Conventionally, the voltage across the short-time rated pull-in coil is removed when the solenoid contacts close. In the present invention, a transistor 60 in the solenoid control circuit turns off after a preset interval to remove voltage from the pull-in coil.

Closing the start switch 10 applies battery voltage to coil 11 of the pilot relay to initiate the engine start sequence. The pilot relay contacts 12 close to apply battery voltage to the solenoid hold coil connected between the G and S solenoid terminals The hold coil return goes directly to battery negative via the G terminal. The closure of the pilot relay contacts also applies positive battery voltage to the positive end of the solenoid pull-in coil.

The pull-in coil return shown in FIG. 3a is preferably connected to pull-in coil control circuit 57. The supply voltage for this circuit is the difference between the voltage on conductors 58 and 59, connected to the negative terminal of the pull-in coil and the negative terminal of the battery, respectively. This supply voltage is only slightly less than the battery voltage because of the low resistance of the pull-in coil and the low level of current drawn by the pull-in control circuit. The pull-in coil control circuit also contains transistor switch 60 between terminals 58 and 59. The transistor switch is held in the open state for typically 150 ms following application of battery voltage to the pull-in control circuit. The pull-in coil control circuit performs two functions: it first charges the bus capacitor 53 through the path provided by the pull-in coil and a ‘pre-charge’ diode 62 and, after the aforementioned 150 ms off-delay, it connects the negative end of the pull-in coil to battery negative for a fixed time interval of typically 150 ms.

FIG. 3b shows the curves of pedestal plus ramp motor voltage 68, smoothly increasing battery and motor current 69 and 70, and torque 71. The end of the cranking process is indicated at time 72 where the voltage, currents and torque go to zero. Note that battery current is less than motor current when the motor voltage is less than the battery voltage. This means that the soft-start requires fewer battery amp-hours for an engine start compared to the hard-start method.

Bus capacitor 53 initially charges with a current limited by the pull-in coil resistance via pre-charge diode 62. If the bus capacitor inrush current is of sufficient amplitude and duration, this current may create enough force on the solenoid plunger to pull in the plunger and thus cause the solenoid contacts 7 to close and the subsequent closure of the power contactor contacts 64. This sequence of events causes full battery voltage to be applied to the bus capacitor. If the solenoid pulls in because of bus capacitor current in the pull-in coil, about 90 ms elapses from the time the pilot relay contacts close until the time that battery voltage is applied to the bus capacitor. During this time, the capacitor will have charged to about 90% of the battery voltage so that the inrush current caused by the closure of the contactor contacts is negligible.

If the bus capacitor charging current is insufficient to cause the solenoid to pull in, the closure of transistor 60 in the solenoid pull-in control circuit 57 ensures pull-in by connecting the battery voltage to the pull-in coil for 150 ms after the initial 150 ms delay. The resulting pull-in coil current will actuate the solenoid and close the solenoid contacts 7 resulting in the application of battery voltage to the power contactor coil 63, the bus capacitor 53 and the positive terminal 55 of the soft-start switch 51. Diode 61 provides a free-wheeling path for the pull-in coil current when transistor switch 60 opens.

In the event of an abutment between the end faces of the pinion gear and ring gear teeth, the solenoid contacts do not close. Following the charging of the bus capacitor through the pull-in coil resistance, the soft-start transistor operates at a low duty cycle of about 10%. The current into the buck converter is limited by the resistance of the pull in coil but the converter increases this current to create sufficient motor torque to break the abutment, thus allowing the solenoid to pull-in, the solenoid contacts to close and the cranking process to proceed. For example, assume the abutment breaks at a motor current of 100 A, the pull-in coil resistance is 0.4 ohm, the battery voltage is 24 V, the duty cycle is 0.1 and the current multiplier is 6. The converter input current is reduced to 100/6=16.7 A. The converter input voltage is 24−16.7*0.4=17.3 V. The motor voltage is 17.3*0.1=1.7 V. This voltage at 100 A will break the abutment by rotating the motor by a few degrees to allow the pinion gear to slip into mesh with the ring gear.

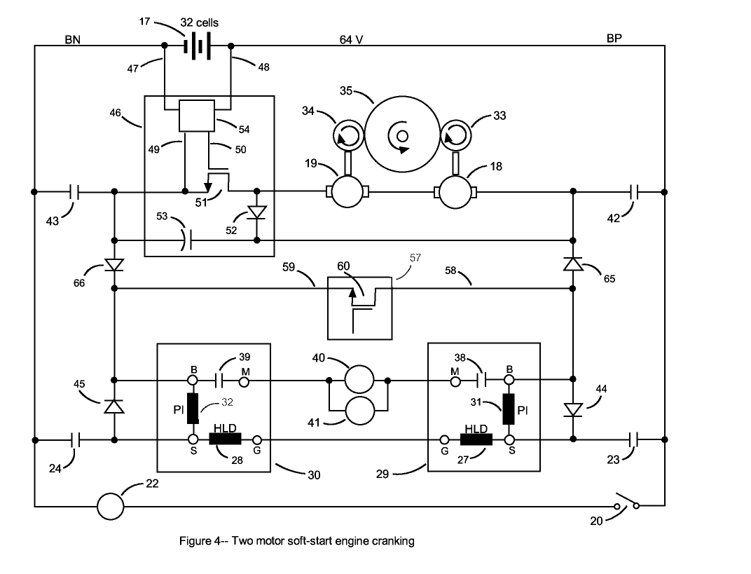

FIG. 4 shows a two-cranking motor soft-start system. It utilizes the same ramp PWM circuit 46 and solenoid pull-in control circuit 57 as the single-motor system of FIG. 3a. The internal connections of the two-motor solenoids 29 and 30 differ from the internal connections of the single motor solenoid.

Also in FIG. 4, pull-in control circuit 57 is connected between the S terminals of the solenoids 29 and 30 to momentarily connect the battery to the two pull-in coils 31 and 32 of the solenoids. Diodes 44 and 45 are paralleled with the pull-in coils to provide free-wheeling current paths for the pull-in coil currents when the transistor switch 60 opens.

Expanding on the single motor soft-start circuit of FIG. 3a, the solenoid pull-in coils provide the bus capacitor pre-charge current limiting resistance by way of their connection to the capacitor through pre-charge diodes 65 and 66. The pull-in controller 57 ensures solenoid pull-in in the event that the bus capacitor pre-charge current is insufficient for the task.

The PWM soft-start circuit is connected between the negative terminal of motor 19 and battery negative. The curves of cranking motor voltage, current and torque vs. time are the same as for the single motor soft-start shown in FIG. 3b.

A preferred sequence of events for the two cranking motor soft-start system in FIG. 4 proceeds as follows:

### A. With No Pinion/Ring Gear Abutment:

1. Start switch 20 (typically activated by a locomotive control computer) energizes the coil 22 of the pilot relay.
2. Pilot relay contacts 23 and 24 close.
3. The voltage of 32 cell battery 17 is applied to hold coils 27 and 28 of solenoids 29 and 30.
4. Battery voltage is also applied to DC bus capacitor 53 through the pull-in coils of the solenoid and diodes 65 and 66, causing the capacitor to charge toward the battery voltage.
5. Transistor switch 60 in the pull-in control circuit 57 is switched on for 150 ms after a 150 ms delay to create current in the pull-in coils 31 and 32.
6. After the pull-in currents are present, the solenoid plungers begin to pull-in and in turn cause the pinion gears 33 and 34 to move toward engagement with the ring gear 35.
7. Soft-start transistor 51, gated by PWM generator 54, switches at a low duty cycle to produce approximately 2.0 V across and 100 A in the two cranking motors 18 and 19. Free-wheeling diode 52 conducts when the transistor switches off to maintain continuous motor current. The low motor voltage produces a safe no-load motor speed if a stuck solenoid causes one or both of the motors to remain unloaded.
9. With neither of pinion gears abutting the ring gear, the pinion gears slide into mesh with the ring gear.
10. Solenoid contacts 38 and 39 close, energizing contactor coils 40 and 41 which cause contactor contacts 42 and 43 to close.
11. The pull-in coils are effectively bypassed.
12. The bus capacitor voltage quickly rises to the battery voltage.
13. Motor rotation stops because current is initially insufficient to rotate the diesel engine.
14. The duty cycle of soft-start transistor 51 increases to 100% over a period of 6 to 10 seconds—this period being selected to minimize cranking motor inrush current and torque.
15. Current provided to the cranking motors increases up to the breakaway torque and the engine begins to rotate.
16. The motor voltage increases to 100% of the battery voltage, minus the on-state voltage drop of less than 0.5 V in the soft-start transistor.
17. The engine speed increases to the firing speed.
18. Fuel injection begins.
19. The engine fires and speed increases.
20. Start switch 20 is opened (typically by the locomotive control computer) to remove current from the coil 22 of the pilot relay when the engine speed exceeds a threshold speed.
21. Pilot relay contacts 23 and 24 open, causing current in the hold coils 27 and 28 to go to zero.
22. The spring loaded solenoid plunger extends, causing the solenoid contacts to open, the current in contactor coils 40 and 41 to go to zero and the pinion gears to dis-engage from the ring gear.
23. Contactor contacts 42 and 43 open to disconnect the battery from the two cranking motors.

### A. With Pinion/Ring Gear Abutment:

1. If both pinion gears abut the ring gear, the motor current, with the solenoid pull-in coils un-bypassed by the solenoid contacts, produces enough torque to break the abutment.
2. Gears mesh and the solenoid contacts close.
3. The cranking process proceeds to completion
4. If one pinion abuts the ring gear, the associated motor spins unloaded at a safe speed until the locomotive computer aborts the cranking sequence by opening switch 20.

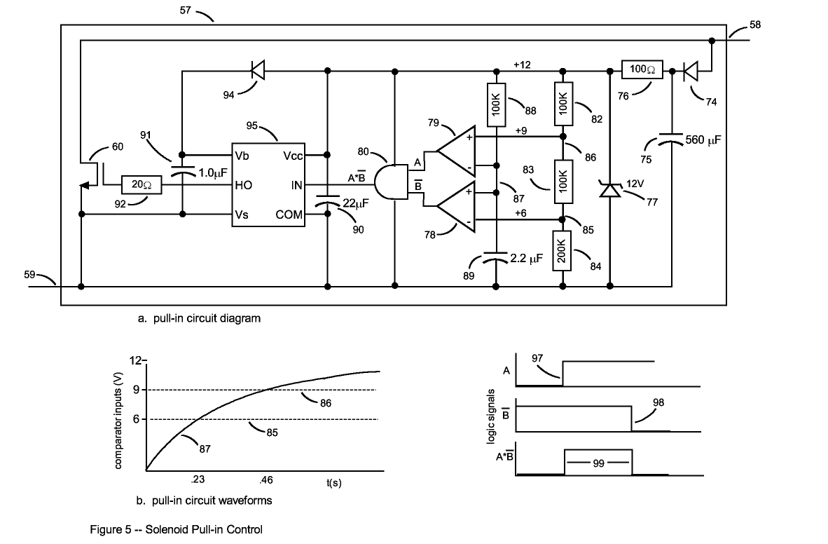

FIG. 5a shows the details of the solenoid pull-in control circuit 57. This circuit is suitable for use with one-motor or two-motor soft-start engine cranking systems.

For application to the one-motor soft-start described in FIG. 3a, battery voltage, slightly reduced by the voltage drop in the relatively low resistance of the solenoid pull-in coil 6, is applied to the pull-in control circuit 57 via conductor 58 when pilot relay contacts 12 close shortly after the contacts 10 of the start switch are closed to initiate the cranking sequence. At this time, storage capacitor 75 of FIG. 5a, having a typical capacitance of 560 μF, quickly charges through diode 74 to the nominal 24 V open circuit battery voltage (or 32 V for a 2-motor cranking system). The charge stored in the capacitor supports the operation of the solenoid pull-in control circuit during the 150 ms period that the transistor switch 60 is conductive, a condition that removes the supply voltage to the pull-in control circuit.

Current limiting resistor 76 of FIG. 5a having a typical resistance of 100Ω and 12 V zener diode 77 form a shunt voltage regulator that supplies 12 V to voltage comparators 78 and 79, AND gate 80 and the resistor divider comprised of 100 kΩ resistors 82 and 83 and 200 kΩ resistor 84. This voltage divider forms 6 V and 9 V reference voltages 85 and 86 that are applied to the inverting input of comparator 78 and the non-inverting input of comparator 79. The 12 V supply voltage is also applied to the RC circuit comprised of 100 kΩ resistor 88 and 2.2 μF capacitor 89. The time constant of this low pass filter circuit is 220 ms.

The curves of voltage vs. time of FIG. 5b show the comparator 6 V and 9 V references 85 and 86, the increasing voltage at the comparator inputs, the comparator output logic signals A and NOT(B) as well as the AND gate output A*NOT(B). It can be shown that the delay in the 0 to 1 change 97 of logic signal A is 0.69*RC, or 150 ms for the 220 ms time constant. It can be also shown that the delay in the 1 to 0 change 98 of logic signal NOT(B) is 300 ms. It follows that the duration of the pull-in coil current command 99 is 150 ms.

The 12 V supply voltage of FIG. 5a also charges capacitor 91 to about 11.5 V via diode 94. Connected between the Vb and Vs terminals of a MOSFET driver 95, capacitor 91 serves as a high current supply to quickly charge the gate-to-source capacitance of the MOSFET transistor 60 when the driver's internal transistor switch turns on to connect the charged capacitor 91 to the driver HO output. The MOSFET driver 91 may be an International Rectifier IR2117 or similar device. The current limiting resistor 92 having a nominal resistance of 20 ohms conducts the 150 ms duration gate current pulse from the HO output of MOSFET driver 95 to the gate terminal of transistor switch 60. The switch changes from open circuit to a virtual short circuit, thus connecting the pull-in coil of the single motor solenoid 4 of FIG. 3a to battery negative for 150 ms.

When the solenoid pull-in control circuit of FIG. 5a is used with the two-motor soft-start of FIG. 4, storage capacitor 75 of FIG. 5a charges to the nominal 64 V open circuit voltage of the 32 cell battery. As with the single motor soft-start, the shunt voltage regulator comprised of 100Ω resistor 76 and zener diode 77 provide 12 V to the pull-in control circuit.

The two-motor soft-start requires that transistor switch 60 of FIG. 4 be connected between the pull-in coil 31 of solenoid 29 and the pull-in coil 32 of solenoid 30.

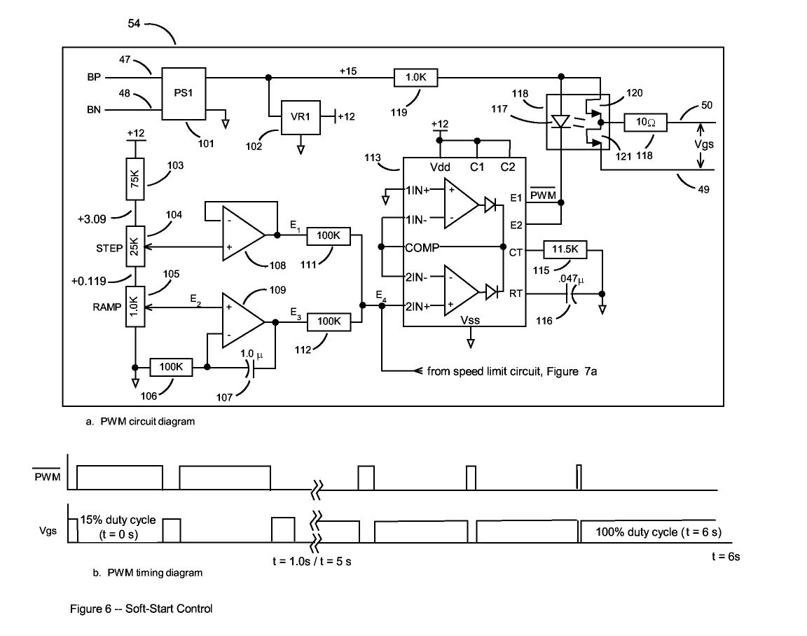

FIG. 6a shows the circuit details of one possible implementation of PWM soft-start control circuit 54. The circuit is preferably powered by an isolated dc-dc converter 101 which is sourced from the battery voltage via conductors 47 and 48. The converter preferably operates over an input voltage range of 18 V to 74 V, making it suitable for use with 12 cell or 32 cell batteries. The converter's 15 V output is preferably applied to the input of a 12 V linear voltage regulator 102 of the generic 78L12 type. The 12 V supply serves operational amplifiers 108 and 109, a voltage divider comprised of resistor 103 and potentiometers 104 and 105, and a pulse width modulator integrated circuit 113. The 15 V output of converter 101 is also supplied to the anode of a photo-diode 117 of a MOSFET driver integrated circuit 118 via 1.0 kΩresistor 119.

The voltage divider in FIG. 6a, that produces the reference voltages E₁ and E₂, is comprised of resistor 103 and potentiometers 104 and 105. Voltage E₁ is buffered by a voltage follower formed by connecting the output of operational amplifier 108 to its inverting input. Voltage E₂ serves as the ramp voltage command to the integrator formed by operational amplifier 109, with 1.0 μF capacitor 107 connected from the amplifier output to the non-inverting input and 100 kΩresistor 106 connected from the non-inverting input of amplifier 109 to circuit common.

The integrator output E₃ responds to the command voltage E2 when circuit power is applied as:

E₃=E₂*(1+t/T)

The time constant T is the product of the 1.0 μF capacitance 107 and the 100 kΩresistance 106, or 0.10 s. The outputs of the operational amplifiers 108 and 109 are summed by equal value resistors 111 and 112 to form the PWM ramp command voltage E₄ as:

E₄=0.5*(E₁+E₂+t/T)

The PWM IC 113, typically a TL594 or similar voltage-mode controller, responds to the PWM command to produce a MOSFET gate command duty cycle ranging from 0% at E₄=0.5 V to 100% at E₄=3.5 V. For typical values of E₁=2.0 V and E₂=0.07 V, 100% duty cycle is reached at a time of:

t=0.1*(3.5/0.5−2.0−0.07)/0.07=7.04s

The inverted PWM signal NOT(PWM) from PWM IC 113 is applied to the cathode of the photo-diode 117 of the MOSFET driver IC 118 through the 1.0 kΩ current limiting resistor 119. The high-current opto-coupled driver IC 118 is typically an Avago ACPL3130 device. The driver's high-side driver transistor 120 turns on when the photo-diode is conductive to produce a 15 V gate command (Vgs) between gate conductor 50 and source conductor 49 of the high current soft-start MOSFET (item 51 of FIG. 3a). When the photo-diode current is zero, the low-side driver transistor 121 turns on to effectively connect the gate to the source of the soft-start transistor.

FIG. 6b shows the NOT(PWM) output of the PWM controller IC 113 and the soft-start MOSFET's gate-to-source voltage Vgs at the beginning and the end of the soft-start cranking motor voltage ramp.

The present soft-start engine cranking system may be arranged to use cranking motors rated to operate at a voltage less than that provided by the battery. For example, cranking motors for locomotives as discussed herein are typically rated to operate on 32V. However, it may be more economical to instead employ cranking motors rated for 24V, which are readily available and tend to be less expensive than 32V motors. The 24 V cranking motors used in large highway trucks and off-road construction vehicles are mechanically the same as the cranking motors used in EMD locomotives built from the 1940's up to the present time; however, because of the relatively low locomotive production level, the cost of a 32 V motor is much greater than that of a 24 V motor. Thus, a soft-start system in accordance with the present invention might employ, for example, a 64V battery and two 24V cranking motors.

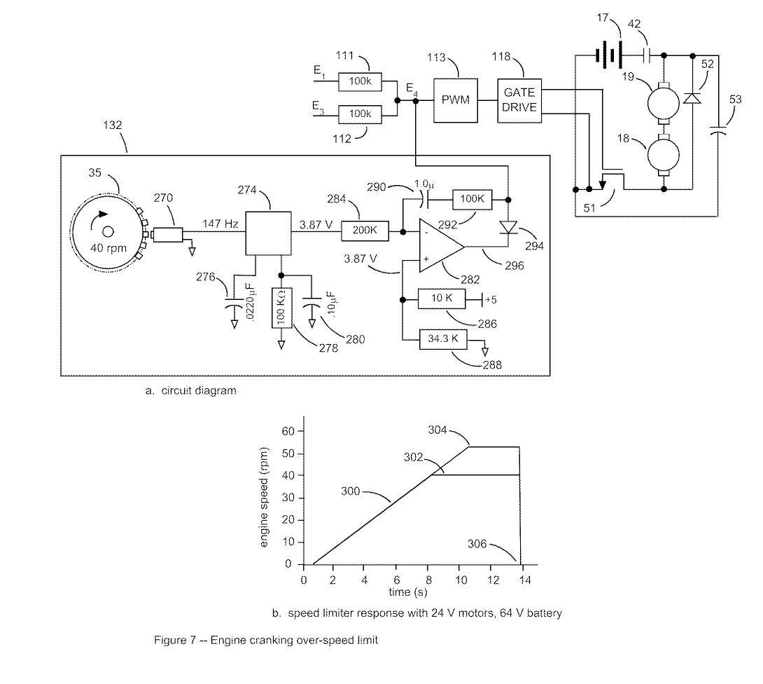

However, cranking speed may become excessive when two 24 V motors operate from a 64 V battery. As such, it may be necessary to provide a speed limiting feature to avoid cranking at a speed corresponding to the torsional resonant frequency of the engine-generator combination. FIG. 7a shows the elements of one possible implementation of a circuit that limits cranking motor speed by limiting the motor voltage when the engine crankshaft speed exceeds a preset limit. A proximity sensor 270 generates a pulse each time a tooth of the flywheel ring gear 35 passes the sensor head. The frequency of the resulting pulse train is converted to a DC voltage by a frequency-to-voltage converter 274, suitably a LM2907 from National Semiconductor. The output voltage vs. frequency constant of this device is given by:

V_{OUT}=F_{IN}*V_{CC}*R1*C1

where C1 and R1 are identified in FIG. 7a as 276 and 278, respectively. A typical locomotive flywheel ring gear has 220 teeth. Thus, at 40 rpm, the proximity sensor produces an output frequency of:

F_{IN}=220*40/60=147 Hz For a typical supply voltage of 12 V and with C1 and R1 values of 0.022 μF and 100 kΩ, respectively, the V/F converter output signal voltage is:

V_{OUT}=147*12*0.10*0.022=3.87V

The converter output voltage includes an AC component at twice the ring gear tooth frequency. This is attenuated by a single pole low pass filter comprised of R1 (278) and C2 (280). At 147 Hz (40 rpm), the attenuation factor is:

2*ω*R1*C1=4*π*147*0.10*0.1=9.10

The filtered crankshaft speed signal is fed to the inverting input of an integrating speed limit amplifier 282 via a resistor 284. The non-inverting input to this amplifier is supplied from a 5V source attenuated with a voltage divider made from a 10 kΩ resistor 286 and a 34.3 kΩ resistor 288, which produces a setpoint voltage of 3.87 V. The feedback circuit of speed limit amplifier 282 is suitably made from a 1.0 μF capacitor 290 in series with a 100 kΩresistor 292 and a diode 294. The cathode of diode 294 is connected to the output 296 of the speed limit amplifier and the anode is connected to feedback resistor 292 and to the junction of resistors 111 and 112 of the PWM ramp circuit shown in FIG. 6a.

PWM ramp circuit resistors 111 and 112 normally conduct the motor voltage ramp command signal E₄ of FIG. 6a to the input of PWM controller IC 113. However, if the engine cranking speed exceeds 40 rpm, F/V converter 274 will produce an output voltage that exceeds the 3.87 V reference at the non-inverting input of speed limit amplifier 282. When this happens, the output voltage 296 of the speed limit amplifier will decrease to a level that causes diode 294 to conduct. This causes speed limit amplifier 282 to take over control of the PWM duty cycle from ramp command voltage E₄, to maintain a cranking motor voltage that limits the cranking speed to 40 rpm. The cranking speed limit setpoint can be made adjustable by replacing one or both of voltage divider resistors 286 and 288 with a potentiometer.

The speed vs. time profiles of FIG. 7b illustrate speed limiting with 24 V motors and a 64 V battery. Assuming that 40 rpm is the maximum speed with 32 V motors and a 64 V battery, 24 V motors increase the maximum speed to 40*(32/24)=53 rpm (304). With resistor 288 selected to give a speed limit of 40 rpm, the duty cycle is limited such that the actual speed ramps (300) up to 40 rpm (302) and holds at that speed until cranking is terminated (306) or until the battery voltage decreases by 24/32=0.75 times its initial voltage. If the speed limit is set to greater than 53 rpm, the duty cycle is allowed to increase to 100% and the speed reaches 53 rpm.

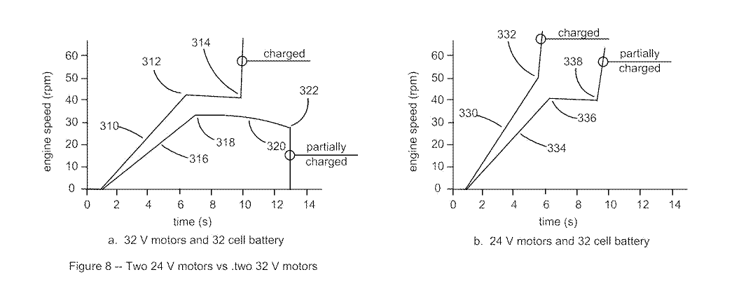

FIG. 8a shows possible speed vs. time profiles for a system with two 32 V motors connected in series and soft-started from a fully charged 32 cell 64 V battery, and from a partially charged battery. The sequence of events for the fully charged battery is:

1. Initial open loop voltage ramp produces the speed ramp 310.
2. Speed reaches 40 rpm (312) and is limited at that speed.
3. Fuel is injected, engine fires, speed rapidly increases (314), and the cranking system shuts down.
The sequence for a partially charged battery is:
1. Initial open loop voltage ramp produces a reduced speed ramp 316.
2. Speed reaches 30 rpm (318)
3. Speed droops as cranking time increases (320).
4. The cranking system shuts down (322) before the engine fires.

In FIG. 8b, the 32 V motors have been replaced by 24 V motors. The sequence of events for the fully charged battery is:

1. Initial open loop voltage ramp produces the speed ramp 330.
2. Speed reaches 50 rpm, fuel is injected, speed increases, cranking system shuts down at 332.
The sequence for a partially charged battery is:
1. Initial open loop voltage ramp produces the reduced speed ramp 334.
2. Speed reaches 40 rpm at 336.
3. Speed, initially 40 rpm, droops slightly until fuel is injected whereupon speed increases and cranking system shuts down at 338.

In comparing the use of a 24 V motor versus a 32 V motor, the speed of the 24 V motor is about 32/24=1.33 times higher for the same battery voltage. The soft-start converter exploits the speed overhead of the 24 V motor in two ways:

1. With a fully charged battery, cranking speed is increased, thus reducing the time to fire the engine.
2. With a partially charged battery, a cranking speed sufficient to fire the engine is reached in cases where the firing speed would not be reached with two 32 V motors directly connected to the battery.

The embodiments of the invention described herein are exemplary and numerous modifications, variations and rearrangements can be readily envisioned to achieve substantially equivalent results, all of which are intended to be embraced within the spirit and scope of the invention as defined in the appended claims.

I claim:

1. A soft-start engine cranking system for engines which are started using an electric cranking motor, comprising:
at least one cranking motor; and
a switching power converter having an output which is coupled to said at least one cranking motor such that the voltage across said at least one cranking motor varies with the duty cycle at which said switching power converter is operated;
said system arranged such that the duty cycle of said switching power converter, and thereby the voltage across said at least one cranking motor, is gradually increased over a predetermined period.

2. The system of claim 1, wherein said at least one cranking motor is operatively coupled to drive a pinion gear which is brought into engagement with a ring gear when starting said engine, said system arranged such that the duty cycle of said switching power converter is gradually increased over a predetermined period such that the resultant torque of said cranking motors is sufficient to break an abutment that may be present between said pinion gear and said ring gear.

3. The system of claim 2, wherein said switching power converter is a buck converter.

4. The system of claim 2, further comprising a solenoid having a pull-in coil which, when energized, causes a plunger to move and thereby bring said pinion gear into engagement with said ring gear.

5. The system of claim 1, further comprising a battery having positive and negative terminals and wherein said at least one cranking motor has first and second terminals, said switching power converter comprising:
a transistor connected between the first terminal of said at least one cranking motor and said negative battery terminal;
a freewheeling diode connected in parallel with said at least one cranking motor;
a pulse-width modulated (PWM) controller arranged to switch said transistor on and off and thereby control the duty cycle of said switching power converter; and
a DC bus capacitor connected between the second terminal of said at least one cranking motor and said negative battery terminal.

6. The system of claim 5, wherein said transistor is high current MOSFET and said diode is a fast recovery epitaxial diode (FRED).

7. The system of claim 1, wherein said at least one cranking motor is operatively coupled to drive a pinion gear which is brought into engagement with a ring gear when starting said engine, further comprising:
a solenoid having a pull-in coil which, when energized, causes a plunger to move and thereby bring said pinion gear into engagement with said ring gear; and
a pull-in coil control circuit arranged to delay energizing said pull-in coil until said DC bus capacitor is at least partially charged.

8. The system of claim 7, further comprising a pre-charge diode, said system arranged such that a charging current is provided to said bus capacitor via said pull-in coil and said pre-charge diode prior to activation of said switching power converter.

9. The system of claim 5, wherein said battery provides X volts and said at least one cranking motor is rated to operate at Y volts, said system arranged such that Y<X.

10. The system of claim 9, said system arranged such that the duty cycle of said switching power converter limits the voltage across said at least one cranking motor to no more than Y volts.

11. The system of claim 9, wherein X is 32 volts and Y is 24 volts.

12. The system of claim 1, wherein said at least one cranking motor consists of two cranking motors connected in series.

13. A soft-start engine cranking system for starting engines which employ an electric cranking motor, comprising:
a battery having positive and negative terminals;
a cranking motor having first and second terminals and which is operatively coupled to drive a pinion gear which is brought into engagement with a ring gear when starting said engine;
a solenoid having a pull-in coil which, when energized, causes a plunger to retract and thereby bring said pinion gear into engagement with said ring gear;
a buck converter having an output which is coupled to said cranking motor such that the voltage across the terminals of said cranking motor varies with the duty cycle at which said buck converter is operated, said buck converter comprising:
a transistor connected between the first terminal of said cranking motor and said negative battery terminal;
a freewheeling diode connected in parallel with said cranking motor;
a pulse-width modulated (PWM) controller arranged to switch said transistor on and off and thereby control the duty cycle of said switching power converter; and
a DC bus capacitor connected between the second terminal of said cranking motor and said negative battery terminal;
said system arranged such that the duty cycle of said switching power converter, and thereby the voltage across said cranking motor, is gradually increased over a predetermined period such that the resultant torque of said cranking motor is sufficient to break an abutment that may be present between said pinion gear and said ring gear.

14. The system of claim 13, wherein said solenoid further comprises a pair of contacts that are connected together when said plunger has substantially completed its retraction, said system arranged such that when said contacts are connected together, said positive battery terminal is connected to the second terminal of said cranking motor, said system arranged such that:
a charging current is provided to said bus capacitor prior to activation of said buck converter;
said buck converter is activated and said pull-in coil is energized when said bus capacitor has been at least partially charged; and
said pull-in coil is de-energized when said solenoid contacts are connected together.

15. The system of claim 13, wherein said battery provides X volts and said cranking motor is rated to operate at Y volts, said system arranged such that Y<X and such that the duty cycle of said buck converter limits the voltage across said cranking motor to no more than Y volts.

16. The system of claim 15, wherein X is 32 volts and Y is 24 volts.

17. A soft-start engine cranking system for starting engines which employ two series-connected electric cranking motors, comprising:
a battery having positive and negative terminals;
two series-connected cranking motors, said series-connected cranking motors having first and second terminals and which are operatively coupled to drive respective pinion gears which are brought into engagement with a ring gear when starting said engine;
first and second solenoids having respective pull-in coils which, when energized, cause respective plungers to retract and thereby bring a respective pinion gear into engagement with said ring gear;
a buck converter having an output which is coupled to said cranking motors such that the voltage across the terminals of said series-connected cranking motors varies with the duty cycle at which said buck converter is operated, said buck converter comprising:
a transistor connected between the first terminal of said cranking motor and said negative battery terminal;
a freewheeling diode connected in parallel with said cranking motors;
a pulse-width modulated (PWM) controller arranged to switch said transistor on and off and thereby control the duty cycle of said switching power converter; and
a DC bus capacitor connected between the second terminal of said cranking motor and said negative battery terminal;
said system arranged such that the duty cycle of said switching power converter, and thereby the voltage across series-connected cranking motors, is gradually increased over a predetermined period such that the resultant torque of said cranking motors is sufficient to break an abutment that may be present between said pinion gears and said ring gear.

18. The system of claim 17, wherein each of said solenoids further comprise a pair of contacts that are connected together when said solenoid's plunger has substantially completed its retraction, said system arranged such that when said solenoid contacts are connected together, said positive battery terminal is connected to the second terminal of said series-connected cranking motors, said system arranged such that:
a charging current is provided to said bus capacitor prior to activation of said buck converter;
said buck converter is activated and said pull-in coils are energized when said bus capacitor has been at least partially charged; and
said pull-in coils are de-energized when said solenoid contacts are connected together.

19. The system of claim 17, wherein said battery provides 64 volts and said cranking motors are rated to operate at 24 volts, said system arranged such that the duty cycle of said buck converter limits the voltage across said cranking motors to no more than 24 volts.

20. A method of cranking an engine which employs an electric cranking motor, comprising:
providing at least one cranking motor; and
providing a switching power converter having an output which is coupled to said at least one cranking motor such that the voltage across said at least one cranking motor varies with the duty cycle at which said switching power converter is operated;
ramping the duty cycle of said switching power converter such that the voltage across said at least one cranking motor is gradually increased over a predetermined period.
